(19) United States
(12) Patent Application Publication
(10) Pub. No.: US 2026/0323636 A1
(43) Pub. Date: Oct. 15, 2026

(54) TECHNOLOGIES FOR MULTI-CELL SCHEDULING

(71) Applicant: Apple Inc., Cupertino, CA (US)

(72) Inventors: Ankit Bhamri, Haar Bavaria-Bayern (DE); Chunhai Yao, Beijing (CN); Dawei Zhang, Saratoga, CA (US); Haitong Sun, Saratoga, CA (US); Wei Zeng, Saratoga, CA (US); Huaning Niu, San Jose, CA (US); Oghenekome Oteri, San Diego, CA (US)

(73) Assignee: Apple Inc., Cupertino, CA (US)

(21) Appl. No.: 18/875,092

(22) PCT Filed: Nov. 30, 2023
(86) PCT No.: PCT/CN2023/135511

§ 371 Date: Dec. 13, 2024

(51) Int. Cl. H04W 72/1273; H04W 72/232

(52) U.S. Cl. CPC H04W 72/1273; H04W 72/232

(57) ABSTRACT

The present application relates to devices and components, including apparatus, systems, and methods for multi-cell scheduling.

### REFERENCE TO RELATED APPLICATION

The present application is a 371 U.S. National Phase of PCT International Patent Application No. PCT/CN2023/135511, filed Nov. 30, 2023, entitled “TECHNOLOGIES FOR MULTI-CELL SCHEDULING,” the disclosure of which is hereby incorporated by reference herein in its entirety.

### TECHNICAL FIELD

This application relates generally to communication networks and, in particular, to technologies for multi-cell scheduling.

### BACKGROUND

Cross-carrier scheduling is a feature that allows a serving cell to schedule resources of another serving cell. Cross-carrier scheduling may enhance network performance by allowing more efficient use of available resources and increasing flexibility in managing resource allocation for multiple carriers. Cross-carrier scheduling may be used to balance the loads across different component carriers.

Cross-carrier scheduling may support different numerologies. For example, carriers may use different numerologies, such as subcarrier spacing (SCS) or slot duration. Cross-carrier scheduling may be effective where the scheduling carrier has a larger bandwidth than the scheduled carriers.

### BRIEF DESCRIPTION OF THE DRAWINGS

FIG. 1 illustrates a network environment in accordance with some embodiments.

FIG. 2 illustrates aspects of the user equipment (UE) operation in accordance with some embodiments.

FIG. 3 illustrates aspects of the UE operation in accordance with some embodiments.

FIG. 4 illustrates aspects of the UE operation in accordance with some embodiments.

FIG. 5 illustrates an operational flow/algorithmic structure in accordance with some embodiments.

FIG. 6 illustrates an operational flow/algorithmic structure in accordance with some embodiments.

FIG. 7 illustrates a user equipment in accordance with some embodiments.

FIG. 8 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

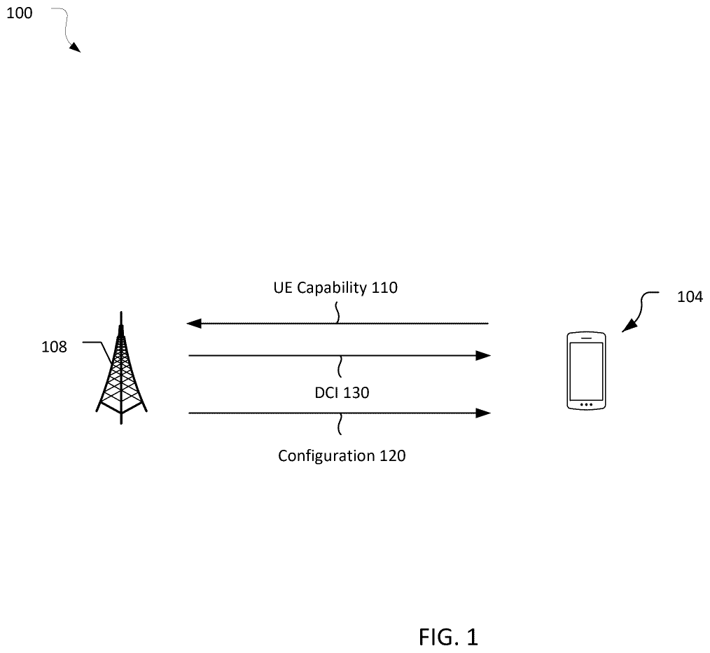

FIG. 1 illustrates a network environment 100 in accordance with some embodiments. The network environment 100 may include a user equipment (UE) 104 communicatively coupled with a base station (BS) 108 of a radio access network (RAN). In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and the base station 108 communicate may be compatible with 3GPP technical specifications (TSs), such as those that define Fifth Generation (5G) NR or later system standards (e.g., Sixth Generation (6G) standards). The base station 108 may provide user plane and control plane protocol terminations toward the UE 104.

During the initial setup and registration, the UE 104 may provide its capabilities to the BS 108. The UE capability information may include support of features such as frequency bands and band combinations, network capabilities, radio capabilities, carrier aggregation, and detail parameters associated with each category. The UE 104 may send UE capability 110 to provide its capabilities to the BS 108. For example, the UE 104 may send the UE capability 110 in a radio resource control (RRC) setup complete, security mode complete, or reconfiguration complete message.

The BS 108 may configure the UE 104 with one or more component carriers. A component carrier may be a block of spectrum used for data transmission between the UE 104 and the BS 108. A configured component carrier may be referred to as a serving cell or simply a cell. Each serving cell may have a configuration of its own that may differ from the configuration of another. The BS 108 may send configuration 120 to configure the UE 104. Configuration 120 may include information to configure a component carrier, e.g., a serving cell. For example, configuration 120 may include but is not limited to, parameters such as frequency band, bandwidth, SCS, and transmission scheme for configuring a cell. The BS 108 may send the configuration 120 using RRC signaling.

The BS 108 may schedule uplink (UL) resources for UL transmissions. UL transmission may include control or data transmission from the UE 104 to the BS 108. The UE 104 may send control information on the UL control channel or UL data channel. For example, the UE 104 may send the control information on the physical uplink control channel (PUCCH) or the physical uplink shared channel (PUSCH). The UE 104 may send the UL data on the UL data channel. For example, the UE 104 may send the UL data on the PUSCH.

The BS 108 may schedule downlink (DL) resources for DL transmission. DL transmission may include control or data transmission from the BS 108 to the UE 104. The BS 108 may send control information on the DL control or DL data channels. For example, the BS 108 may send the control information on the physical downlink control channel (PDCCH) or the physical downlink shared channel (PDSCH). The BS 108 may send the DL data on the DL data channel. For example, the BS 108 may send the DL data on the PDSCH.

The BS 108 may use DL control information (DCI) to schedule UL or DL resources. For example, the BS 108 may send the DCI 130 to the UE 104 to schedule UL or DL resources. In some instances, a DCI may schedule resources associated with a single cell. In other instances, a DCI may schedule resources associated with more than cells. In some instances, the DCI may be used to schedule a group of UEs. In some instances, the DCI may be used to schedule a single UE. The DCI used to schedule a single UE may be called unicast DCI.

The UE 104 may receive the DCI 130 on resources associated with a cell referred to as a scheduling cell. The DCI 130 may include scheduling information of one or more cells called scheduled cells. In some instances, the scheduling cell may be a scheduled cell. However, in general, a scheduling cell is not required to be a scheduled cell.

In some instances, the UE 104 does not know the resources used for transmission of DCI. The UE may monitor a set of resources to determine the resources associated with the control channel. The UE may perform an exhaustive set of hypotheses testing within the control channel resources to identify DCIs. This process may be referred to as blind decoding. The UE 104 may be configured with one or more control resource sets (CORESET) to get the location of the PDCCH. The UE 104 may perform blind decoding in a search space inside the CORESETs. For example, configuration 120 may configure the CORESETs at the UE 104.

Blind decoding may be a complex process. It is desired to reduce the number of blind decoding attempts performed by the UE 104. However, support for single-cell scheduling and multi-cell scheduling increases the number of DCIs that the UE may expect to receive, increasing the number of blind decoding that the UE must perform. Therefore, it is desired to reduce or limit the total number of blind decoding the UE performs.

In some instances, the UE 104 may perform slot-based monitoring. The scheduling cell and scheduled cell may have the same SCS. In slot-based monitoring, the UE 104 may process one unicast DCI scheduling DL and one unicast DCI scheduling UL at each slot associated with a scheduling cell (or scheduling component carrier) for frequency division duplex (FDD). The UE 104 may process one unicast DCI scheduling DL and two unicast DCI scheduling UL at each slot associated with a scheduling cell (or scheduling component carrier) for the time division duplex (TDD).

In some instances, the configured cells (or component carriers) may have different SCSs.

When the SCS of the scheduling cell is smaller than the SCS of the scheduled cell, the UE capability may be the same as for the example above, where the SCS of the scheduling cell and the scheduled cells are the same. The UE 104 may process one unicast DCI scheduling DL and one unicast DCI scheduling UL at each slot associated with a scheduling cell (or scheduling component carrier) for frequency division duplex (FDD). The UE 104 may process one unicast DCI scheduling DL and two unicast DCI scheduling UL at each slot associated with a scheduling cell (or scheduling component carrier) for the time division duplex (TDD). The UE may support advanced capability. The UE capability may indicate that the UE may process up to X unicast DCI scheduling for DL for each scheduled component carrier. The value of X may be based on the SCS of the scheduling component carrier and the SCS of the scheduled component carrier, e.g., a pair of SCS in the form of (scheduling component carrier SCO, scheduled component carrier SCS). For example, the UE capability may indicate that the UE may support 1, 2, or 4 unicast DCI scheduling for DL for SCS pairs of (15, 120), (15, 60), and (30, 120). It means that the UE may support 1, 2, or 4 unicast DCI scheduling for DL when the scheduling cell SCS is 15 kilo Hertz (kHz) and the scheduled cell SCS is 120 kHz. Similarly, the UE may support 1, 2, or 4 unicast DCI scheduling for DL when the scheduling cell SCS is 15 kHz and the scheduled cell SCS is 60 kHz, and the UE may support 1, 2, or 4 unicast DCI scheduling for DL when the scheduling cell SCS is 30 kHz, and the scheduled cell SCS is 120 kHz.

In another example, the UE capability may indicate that X={2} for (15, 30), (30, 60), (60, 120). It means that the UE may support two unicast DCI scheduling for DL when the scheduling cell SCS is 15 kHz and the scheduled cell SCS is 30 kHz. Similarly, the UE may support two unicast DCI scheduling for DL when the scheduling cell SCS is 30 kHz, and the scheduled cell SCS is 60 kHz, and the UE may support two unicast DCI scheduling for DL when the scheduling cell SCS is 60 kHz, and the scheduled cell SCS is 120 kHz.

Similarly, the UE capability may include the UE capability for processing unicast DCI scheduling for UL per component carrier. The UE capability may use the same format described above for DL scheduling. For example, the UE capability may indicate that UE may process up to Y unicast DCI scheduling for UL per scheduled component carrier. For example, the UE capability may indicate Y={1, 2, 4} for (15, 120), (15, 60), and (30, 120). It means that the UE may support 1, 2, or 4 unicast DCI scheduling for UL when the scheduling cell SCS is 15 kHz and the scheduled cell SCS is 120 kHz. Similarly, the UE may support 1, 2, or 4 unicast DCI scheduling for UL when the scheduling cell SCS is 15 kHz and the scheduled cell SCS is 60 kHz, and the UE may support 1, 2, or 4 unicast DCI scheduling for UL when the scheduling cell SCS is 30 kHz, and the scheduled cell SCS is 120 kHz.

In another example, the UE capability may indicate that Y={2} for (15, 30), (30, 60), (60, 120). It means that the UE may support two unicast DCI scheduling for UL when the scheduling cell SCS is 15 kHz and the scheduled cell SCS is 30 kHz. Similarly, the UE may support two unicast DCI scheduling for UL when the scheduling cell SCS is 30 kHz and the scheduled cell SCS is 60 kHz, and the UE may support two unicast DCI scheduling for UL when the scheduling cell SCS is 60 kHz, and the scheduled cell SCS is 120 kHz.

When the SCS of the scheduling cell is greater than the SCS of the scheduled cell, the UE's capability may indicate that the UE may process one unicast DCI scheduling DL for each component carrier during U consecutive slots associated with the scheduling component carrier. The limit on the number of DCIs that can be processed may be the same for TDD and FDD. The UE may determine the value of U based on a pair of (scheduling component carrier SCS and scheduled component carrier SCS). For example, U=2 for (30, 15), (60, 30), (120, 60) may mean that the UE may process one DCI scheduling DL in two consecutive slots of the scheduling cell when the scheduling cell SCS is 30 kHz and the scheduled cell SCS 15 kHz, the scheduling cell SCS is 60, and the scheduled cell SCS is 30 kHz, or the scheduling cell SCS is 120 and the scheduled cell SCS is 60 kHz.

In another example, U=4 for (60, 15) and (120, 30) may be interpreted by the UE to process one DCI scheduling DL in four consecutive slots of the scheduling cell when the scheduling cell SCS is 60 kHz, and the scheduled cell SCS is 15 kHz, or when the scheduling cell SCS is 120 kHz, and the scheduled cell SCS is 30 kHz.

In another example, U=8 for (120, 15) may be interpreted by the UE to process one DCI scheduling DL in eight consecutive slots of the scheduling cell when the scheduling cell SCS is 120 kHz and the scheduled cell SCS is 15 kHz.

A single DCI may schedule a set of cells. The DCI may include an indication identifying one or more cells and allocating resources to each identified cell. For example, the BS 108 may send a DCI format 1_3 to schedule PDSCHs associated with multiple cells. In one example, the UE may process one unicast DCI per slot of scheduling cell for the multi-cell PDSCH scheduling for both FDD and TDD.

The BS 108 may send a DCI format 0_3 to schedule PUSCH associated with multiple cells. In one example, the UE 104 may process one unicast DCI per slot of scheduling cell for multi-cell PUSCH scheduling for the FDD scheduling cell. The UE may process two unicast DCI per slot of scheduling cell for multi-cell PUSCH scheduling for TDD scheduling cell.

In some embodiments, the number of unicast DCIs that the UE can process within a slot is determined when the scheduling cell schedules multiple cells with different SCSs. In some instances, the co-scheduled cells have different SCSs, but all SCSs are smaller than the SCS of the scheduling cell. In some instances, the co-scheduled cells have different SCSs, but all SCSs are larger than the SCS of the scheduling cell. In some instances, the co-scheduled cells have different SCSs; some have SCSs smaller than the SCS of the scheduling cell, and others have SCSs larger than the SCS of the scheduling cell.

In one embodiment, the total number of unicast DCIs is determined based on the SCS of the scheduling cell and the SCSs of the scheduled cells. In another embodiment, the number of slots of the scheduling cell that the UE 104 monitors for DCI is determined based on the SCS of the scheduling cell and the SCSs of the scheduled cell.

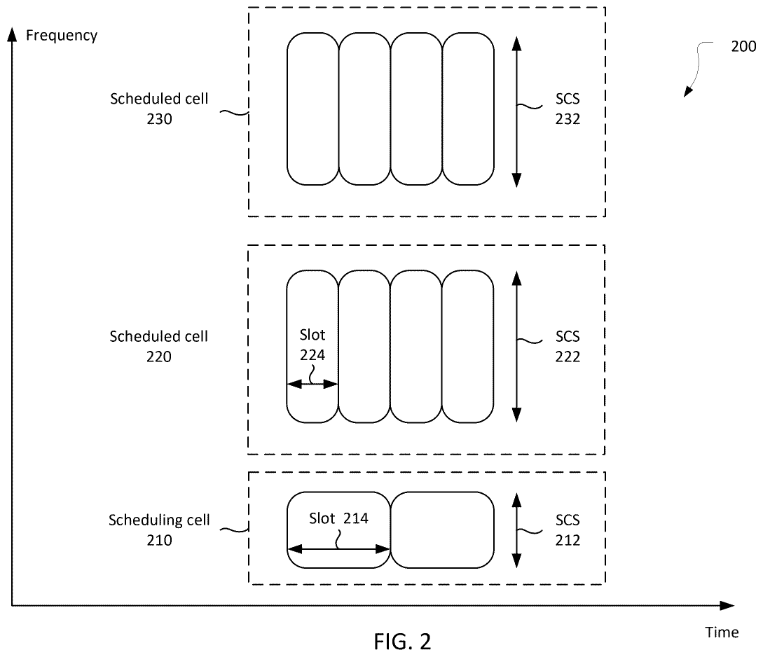

FIG. 2 illustrates aspects of the user equipment (UE) operation 200 in accordance with some embodiments. The scheduling cell 210 schedules two scheduled cells 220 and 230. Slots 214 and SCS 212 are associated with scheduling cell 210. The SCS 212 of the scheduling cell 210 is smaller than (or equal to) the SCS 222 of the scheduled cell 220 and the SCS 232 of the scheduled cell 230. In some instances, the SCS 222 and 232 are equal. In some instances, the SCS 222 and 232 are not equal.

In some instances, when the SCS associated with a transmission is increased, the duration of the transmission is reduced. The SCS 212 of the scheduling cell 210 is smaller than the SCS 222 of the scheduled cell 220, and the slot 214 of the scheduling cell 210 is larger than the slot 224 of the scheduled cell 220. Therefore, during the time, e.g., slot 214, that the UE received the control information on the scheduling cell 210, the UE may receive (or transmit) on more than one slot on the scheduled cells 220 or 230. Control information received on one slot of the scheduling cell 210 may be used to schedule multiple slots on each of the scheduled cells 220 or 230. Therefore, sending multiple DCIs to schedule multiple resources on each scheduled cell 220 may improve the utilization of the network resources.

The UE may be capable of and configured with both multi-cell scheduling and single-cell scheduling for DL or UL. The UE may be configured with M co-scheduled cells (only two co-scheduled cells are illustrated in FIG. 2). The SCS of the scheduling cell, denoted by SCS₀, is smaller than or equal to the SCS of each of the co-scheduled cells, e.g., SCS₀<=SCSₘ for m=1, 2, 3, . . . , M. The SCS among co-scheduled cells may be different.

In one embodiment, the total number of unicast DCIs (including single-cell and multi-cell scheduling DCIs) for a UE to process for the set of cells within a slot is based on the combination of (SCS₀, max {SCS₁, SCS₂, . . . , SCS_{M}}).

For example, consider that SCS₀=15 kHz, M=2, SCS₁=15 kHz, and SCS₂=30 kHz. The UE capability may indicate the number of unicast DCIs that the UE may process for different (scheduling cell SCS, scheduled cell SCS) combinations. For example, the UE capability may indicate that the UE may process two DCIs for (15 kHz, 30 kHz) combination. The total number of unicast DCIs (including single-cell and multi-cell scheduling DCIs) for the UE is based on the combination of (SCS₀=15 kHz, max {SCS₁=15 kHz, SCS₂=30 kHz})=(15 kHz, 30 kHz). The combination, e.g., (15 kHz, 30 kHz) is associated with the capability of processing two DCIs. Therefore, the total number of DCIs (including single-cell and multi-cell scheduling DCIs) for the UE is two.

In one embodiment, the number of unicast DCIs (including only multi-cell scheduling DCIs) for a UE to process for the set of cells within a slot of scheduling cell is based on the combination (SCS₀, min {SCS₁, SCS₂, . . . , SCS_{M}})

For example, consider that SCS₀=15 kHz, M=2, and SCS₁=15 kHz, and SCS₂=30 kHz. The UE capability may indicate the number of unicast DCIs that the UE may process for different (scheduling cell SCS, scheduled cell SCS) combinations. For example, the UE capability may indicate that the UE may process one DCI for (15 kHz, 15 kHz) combination. The number of unicast DCIs (including only the multi-cell scheduling DCIs) for the UE is based on the combination of (SCS₀=15 kHz, min {SCS₁=15 kHz, SCS₂=30 kHz})=(15 kHz, 15 kHz). The combination (15 kHz, 30 kHz), based on the UE capability, is associated with the capability of processing one DCI. Therefore, the number of DCIs (including only multi-cell scheduling DCIs) for the UE is one.

In some embodiments, the total number of unicast DCIs (including both single-cell and multi-cell scheduling DCIs) for the set of cells may be no more than the sum of limits corresponding to each combination of scheduling cells and co-scheduled cell within the set. In the example above, the total limit is the sum of unicast DCIs to be processed for the combination of (SCS₀=15 kHz, SCS₁=15 kHz)=(15 kHz, 15 kHz) and (SCS₀=15 kHz, SCS₂=30 kHz)=(15 kHz, 30 kHz), where the number of unicast DCIs associated with (15 kHz, 15 kHz) is one (e.g., based on the UE capability information) and the number of unicast DCIs associated with (15 kHz, 30 kHz) is two (e.g., based on the UE capability information). Therefore, the total number of unicast DCIs to be processed by the UE is limited by 1+2=3.

In one embodiment, the total number of unicast DCIs (including single-cell and multi-cell scheduling DCIs) for a UE to process for the set of cells within a slot of the scheduling cell is based on the combination of (SCS₀, min {SCS₁, SCS₂, . . . , SCS_{M}}). In the example above, the total number of unicast DCIs (including single-cell and multi-cell scheduling DCIs) is based on (SCS₀=15 kHz, min {SCS₁=15 kHz, SCS₂=30 kHz})=(15 kHz, 15 kHz), where the number of unicast DCIs associated with (15 kHz, 15 kHz) is one (e.g., based on the UE capability information).

The UE capability may have different values for the number of DCIs the UE may process for UL and DL. The UE capability may have different values for the number of DCIs the UE may process for FDD and TDD.

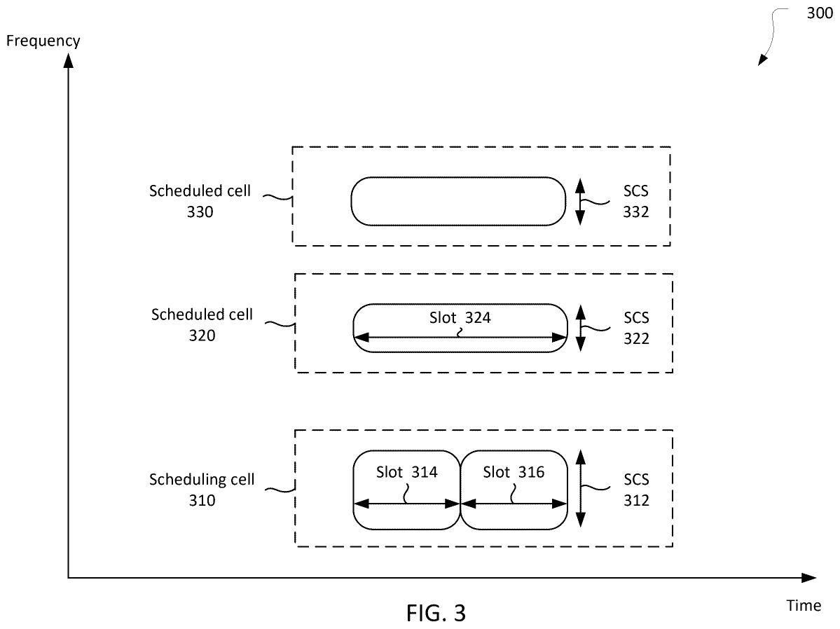

FIG. 3 illustrates aspects of the user equipment (UE) operation 300 in accordance with some embodiments. The scheduling cell 310 schedules two scheduled cells 320 and 330. The slot 314 and SCS 312 are associated with the scheduling cell 310. The SCS 312 of the scheduling cell 310 is greater than (or equal to) the SCS 322 of the scheduled cell 320 and the SCS 332 of the scheduled cell 330. In some instances, the SCS 322 and 332 are equal. In some instances, the SCS 322 and 332 are not equal.

In some instances, when the SCS associated with a transmission is decreased, the duration of the transmission is increased. The SCS 312 of the scheduling cell 310 is greater than the SCS 322 of the scheduled cell 320, and the slot 314 of the scheduling cell 310 is smaller than the slot 324 of the scheduled cell 320. Therefore, during the time, e.g., slots 314 and 316, that the UE received the control information on the scheduling cell 310, the UE may receive (or transmit) on only one slot on the scheduled cells 320 or 330. Control information received on two slots of the scheduling cell 310 may be used to schedule a single slot on each of the scheduled cells 320 or 330. Therefore, sending multiple DCIs to schedule multiple resources on each scheduled cell 320 or 330 may not be needed.

The UE may be capable of and configured with both multi-cell scheduling and single-cell scheduling for DL or UL. The UE may be configured with M co-scheduled cells (only two co-scheduled cells are illustrated in FIG. 2). The SCS of the scheduling cell, denoted by SCS₀, is greater than or equal to the SCS of each of the co-scheduled cells, e.g., SCS₀>=SCSₘ for m=1, 2, 3, . . . , M. The SCS among co-scheduled cells may be different.

In one embodiment, the total number of unicast DCIs (including single-cell and multi-cell scheduling DCIs) for a UE to process for the set of cells is one. The UE may receive the DCI over L consecutive slots of the scheduling cell, wherein L is based on the combination of (SCS₀, max {SCS₁, SCS₂, . . . , SCS_{M}}).

For example, consider that SCS₀=60 kHz, M=2, and SCS₁=15 kHz, and SCS₂=30 kHz. The UE capability may indicate that the UE may process one DCI over four consecutive slots of the scheduling cell for (60 kHz, 15 kHz) combination and two consecutive slots for (60 kHz, 30 kHz). The total number of consecutive slots to process one unicast DCIs (including single-cell and multi-cell scheduling DCIs) for the UE is based on the combination of (SCS₀=60 kHz, max {SCS₁=15 kHz, SCS₂=30 kHz})=(60 kHz, 30 kHz). The combination, e.g., (60 kHz, 30 kHz), is associated with the capability of processing one DCI over two consecutive slots (e.g., based on the UE capability). Therefore, the total number of DCIs (including single-cell and multi-cell scheduling DCIs) for the UE is two.

In one embodiment, the number of unicast DCIs (including only multi-cell scheduling DCIs) for a UE to process for the set of cells is one over L consecutive slots, where the value L is based on the combination (SCS₀, max {SCS₁, SCS₂, . . . , SCS_{M}}).

For example, consider that SCS₀=60 kHz, M=2, and SCS₁=15 kHz, and SCS₂=30 kHz. The value of L is based on the combination (SCS₀=60 kHz, max {SCS₁=15 kHz, SCS₂=30 kHz})=(60 kHz, 30 kHz). The value of L associated with (60 kHz, 30 kHz), based on the UE capabilities, may be two slots.

For the legacy single-cell scheduling DCIs, the number of consecutive slots over which one legacy unicast DCI is processed for a co-scheduled cell may be based on the combination limit between the scheduling cell SCS and co-scheduled cell SCS. For instance, in the example above, the legacy single-cell scheduling DCIs, the number of consecutive slots over which one legacy unicast DCI is processed is based on (60 kHz, 15 kHz). The number of consecutive slots for (60 kHz, 15 kHz) combination may be four slots, based on the UE capabilities.

The UE capability may have different values for the number of DCIs the UE may process for UL and DL. The UE capability may have different values for the number of DCIs the UE may process for FDD and TDD.

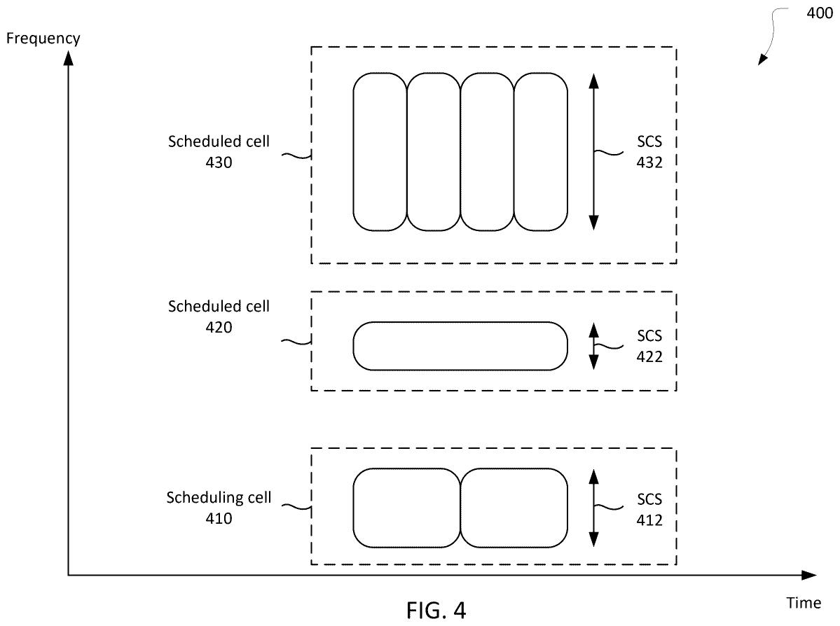

FIG. 4 illustrates aspects of the user equipment (UE) operation 400 in accordance with some embodiments. The scheduling cell 410 schedules two scheduled cells 420 and 430. The SCS 412 is associated with the scheduling cell 410. The SCS 412 of the scheduled cell 410 is greater than (or equal to) the SCS 422 of the scheduled cell 420 and smaller than the SCS 432 of the scheduled cell 430.

The UE may be capable of and configured with both multi-cell scheduling and single-cell scheduling for DL or UL. The UE may be configured with M co-scheduled cells (only two co-scheduled cells are illustrated in FIG. 2). The SCS of the scheduling cell, denoted by SCS₀, is greater than or equal to the SCS of some of the co-scheduled cells and smaller than or equal to SCS of some other co-scheduled cells.

In one embodiment, the total number of unicast DCIs (including only multi-cell scheduling DCIs) for a UE to process for the set of cells is one within a slot of the scheduling cell. The legacy single-cell scheduling DCIs may be determined based on the combination limit between the scheduling cell SCS and co-scheduled cell SCS.

In one embodiment, the total number of unicast DCIs (including single-cell and multi-cell scheduling DCIs) for a UE to process for the set of cells within a slot of the scheduling cell is based on the combination of (SCS₀, max {SCS₁, SCS₂, . . . , SCS_{M}}). For example, consider that SCS₀=30 kHz, M=2, and SCS₁=15 kHz, and SCS₂=60 kHz. The UE capability may indicate that the UE may process two DCI for (30 kHz, 60 kHz) combination. The number of unicast DCIs (including only the multi-cell scheduling DCIs) for the UE is based on the combination of (SCS₀=30 kHz, max {SCS₁=15 kHz, SCS₂=60 kHz})=(30 kHz, 60 kHz). The combination (30 kHz, 60 kHz), based on the UE capability, is associated with the capability of processing two DCI. Therefore, the total number of DCIs (including single-cell and multi-cell scheduling DCIs) for the UE is two. The legacy single-cell scheduling DCIs may be determined based on the combination limit between the scheduling cell SCS and co-scheduled cell SCS.

The UE capability may have different values for the number of DCIs the UE may process for UL and DL. The UE capability may have different values for the number of DCIs the UE may process for FDD and TDD.

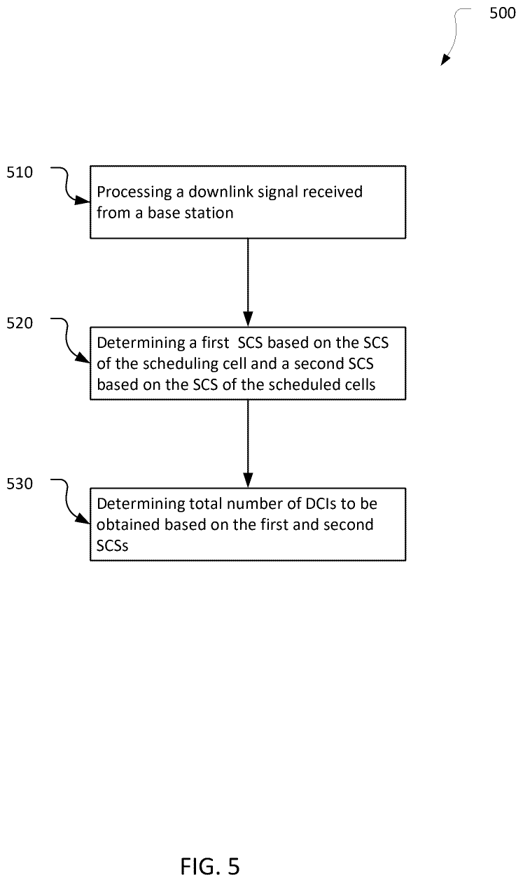

FIG. 5 illustrates an operational flow/algorithmic structure 500 in accordance with some embodiments. Operational flow/algorithmic structure 500 is an example of the UE providing PSI attribute information to the base station. The operation flow/algorithmic structure 500 may be implemented by a UE (for example, UE 104 or UE 700) or components therein, for example, processing circuitry 704.

The operation flow/algorithmic structure 500 may include, at 510, receiving a downlink signal. The UE may receive the downlink signal on a first cell. The first cell may be configured with a first SCS. The downlink signal may include information for scheduling two or more cells, e.g., a second cell having a second SCS and a third cell having a third SCS. The UE may be configured and capable of multi-cell scheduling and single-cell scheduling.

The operation flow/algorithmic structure 500 may include, at 520, determining a fourth SCS based on the second and third SCSs. For example, the fourth SCS may be the minimum of the second and third SCSs. In another example, the fourth SCS may be the maximum of the second and third SCS.

The operation flow/algorithmic structure 500 may include, at 530, determining a total number of unicast DCIs based on the first and fourth SCSs. In some instances, the UE may determine the total number of unicast DCIs based on the first and fourth SCSs and the UE capability information. The total number of DCIs may include the multi-cell scheduling DCIs. The total number of DCIs may include the single-cell scheduling DCIs and multi-cell scheduling DCIs. The UE may not expect to receive and process DCIs that are more than the total number of DCIs. The UE may process DCIs until the number of processed DCIs reaches the determined total number of DCIs or until the UE processes all the downlink DCIs. The UE may be configured to process a number of DCIs within a monitoring slot of the first cell where the number of the processed DCIs is less than or equal to the total number of unicast DCIs

When the SCS of the scheduling cell is larger than the SCS of all the scheduled cells, the UE may determine the total number of unicast DCIs to be one and may determine the number of consecutive slots over which the unicast DCI is expected to be received. The UE may determine the number of consecutive slots based on the UE capability, the first SCS, and the fourth SCS.

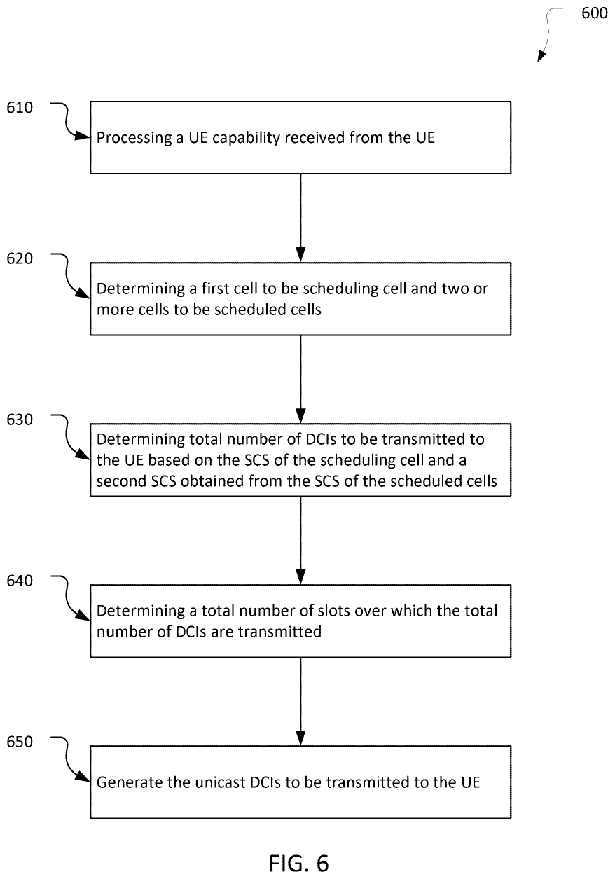

FIG. 6 illustrates an operational flow/algorithmic 600 structure in accordance with some embodiments. Operational flow/algorithmic structure 600 is an example of the operation of the base station 108. The operational flow/algorithmic structure 600 may be implemented by a network node, for example, the network node 800, or components therein, e.g., processors 804.

The operation flow/algorithmic structure 600 may include, at 610, receiving a UE capability. The UE capability may determine the number of DCIs the UE is capable of processing for a pair of (scheduling cell SCS, scheduled cell SCS). The UE capability may include information associated with the number of consecutive slots the UE may monitor to receive a given number of unicast DCI for a pair of (scheduling cell SCS, scheduled cell SCS). The UE capability may include information associated with the total number of DCIs or the total number of consecutive slots for UL or DL transmission using the FDD or TDD scheme.

The operation flow/algorithmic structure 600 may include, at 620, determining a first cell to be a scheduling cell. The first cell may be associated with a first SCS. The BS may also determine a second and third cell to be scheduled. The second cell may be associated with a second SCS, and the third cell may be associated with a third SCS.

The operation flow/algorithmic structure 600 may include, at 630, determining a total number of DCIs based on the UE capability and the first, second, and third SCSs. For example, the BS may determine the total number of DCIs based on whether the first SCS is greater than or equal to the second and third SCS, whether the first SCS is less than or equal to the second and third SCS, or whether the first SCS is greater than or equal to the second SCS and smaller than or equal to the third SCS. The BS may determine a fourth SCS based on the second and third SCS. For example, the fourth SCS may be the minimum or maximum of the second and third SCSs. The BS may determine the total number of unicast DCIs based on the UE capability, the first SCS, and the fourth SCS.

The operation flow/algorithmic structure 600 may include, at 640, determining a total number of consecutive slots over which the total number of unicast DCIs are transmitted to the UE based on the UE capability and the first, second, and third SCSs. For example, the BS may determine the total number of slots based on whether the first SCS is greater than or equal to the second and third SCS, whether the first SCS is less than or equal to the second and third SCS, or whether the first SCS is greater than or equal to the second SCS and smaller than or equal to the third SCS. The BS may determine a fourth SCS based on the second and third SCS. For example, the fourth SCS may be the minimum or maximum of the second and third SCSs. The BS may determine the total number of slots based on the UE capability, the first SCS, and the fourth SCS.

The operation flow/algorithmic structure 600 may include, at 650, generating the unicast DCIs to be transmitted to the UE. The BS may generate at most K unicast DCIs, where K is less than or equal to the total number of DCIs. The BS may allocate resources over L consecutive slots where L is less than or equal to the total number of consecutive slots.

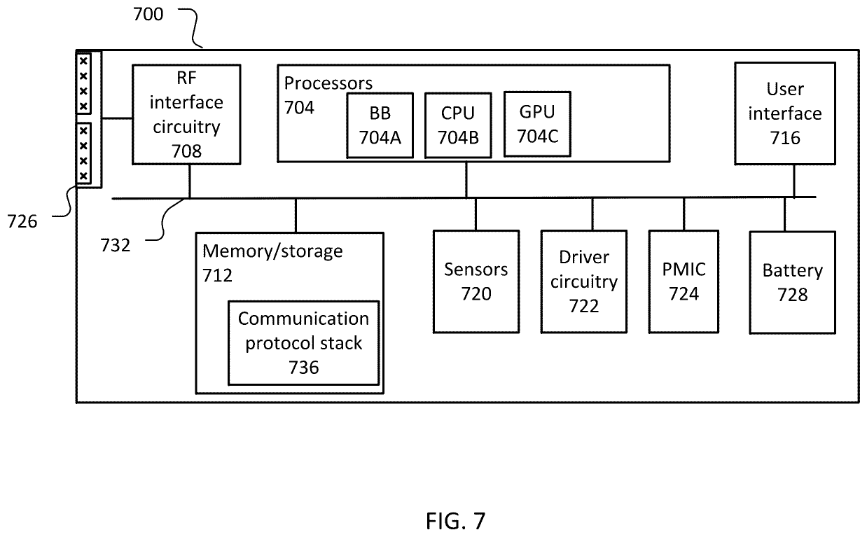

FIG. 7 illustrates a UE 700 in accordance with some embodiments. The UE 700 may be similar to and substantially interchangeable with UE 104 of FIG. 1.

The UE 700 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 700 may include processors 704, RF interface circuitry 708, memory/storage 712, user interface 716, sensors 720, driver circuitry 722, power management integrated circuit (PMIC) 724, the antenna structure 726, and battery 728. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangements of the components shown may occur in other implementations.

The components of the UE 700 may be coupled with various other components over one or more interconnects 732, which may represent any type of interface circuitry (for example, processor interface or memory interface), input/output, bus (local, system, or expansion), transmission line, trace, or optical connection that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry, or processor circuitry that executes or otherwise operates computer-executable instructions, such as program code, software modules, or functional processes from memory/storage 712 to cause the UE 700 to perform operations as described herein.

In some embodiments, the baseband processor circuitry 704A may access a communication protocol stack 736 in the memory/storage 712 to communicate over a 3GPP-compatible network. In general, the baseband processor circuitry 704A may access the communication protocol stack 736 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 708.

The baseband processor circuitry 704A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 712 may include one or more non-transitory, computer-readable media that include instructions (for example, the communication protocol stack 736) that may be executed by one or more of the processors 704 to cause the UE 700 to perform various operations described herein. The memory/storage 712 includes any type of volatile or non-volatile memory that may be distributed throughout the UE 700. In some embodiments, some of the memory/storage 712 may be located on the processors 704 themselves (for example, L1 and L2 cache), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 708 may include transceiver circuitry and a radio frequency front module (RFEM) that allows the UE 700 to communicate with other devices over a radio access network. The RF interface circuitry 708 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 726 and proceed to filter and amplify (with a low-noise amplifier) the signal. The signal may be provided to a receiver of the transceiver that down-converts the RF signal into a baseband signal that is provided to the baseband processor of the processor 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 726.

In various embodiments, the RF interface circuitry 708 may be configured to transmit/receive signals in a manner compatible with NR access technologies.

The antenna 726 may include antenna elements to convert electrical signals into radio waves to travel through the air and to convert received radio waves into electrical signals. The antenna elements may be arranged into one or more antenna panels. The antenna 726 may have antenna panels that are omnidirectional, directional, or a combination thereof to enable beamforming and multiple input, multiple output communications. The antenna 726 may include microstrip antennas, printed antennas fabricated on the surface of one or more printed circuit boards, patch antennas, or phased array antennas. The antenna 726 may have one or more panels designed for specific frequency bands, including bands in FR1 or FR2.

The user interface circuitry 716 includes various input/output (I/O) devices designed to enable user interaction with the UE 700. The user interface 716 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 700.

The sensors 720 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 722 may include software and hardware elements that operate to control particular devices that are embedded in the UE 700, attached to the UE 700, or otherwise communicatively coupled with the UE 700. The driver circuitry 722 may include individual drivers allowing other components to interact with or control various I/O devices that may be present within or connected to the UE 700. For example, the driver circuitry 722 may include circuitry to facilitate the coupling of a universal integrated circuit card (UICC) or a universal subscriber identity module (USIM) to the UE 700. For additional examples, driver circuitry 722 may include a display driver to control and allow access to a display device, a touchscreen driver to control and allow access to a touchscreen interface, sensor drivers to obtain sensor readings of sensor circuitry 720, and control and allow access to sensor circuitry 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage the power provided to various components of the UE 700. In particular, with respect to the processors 704, the PMIC 724 may control power-source selection, voltage scaling, battery charging, or DC-to-DC conversion.

In some embodiments, the PMIC 724 may control or otherwise be part of various power-saving mechanisms of the UE 700, including DRX, as discussed herein.

A battery 728 may power the UE 700, although in some examples, the UE 700 may be mounted and deployed in a fixed location and may have a power supply coupled to an electrical grid. The battery 728 may be a lithium-ion battery, a metal-air battery, such as a zinc-air battery, an aluminum-air battery, a lithium-air battery, and the like. In some implementations, such as in vehicle-based applications, the battery 728 may be a typical lead-acid automotive battery.

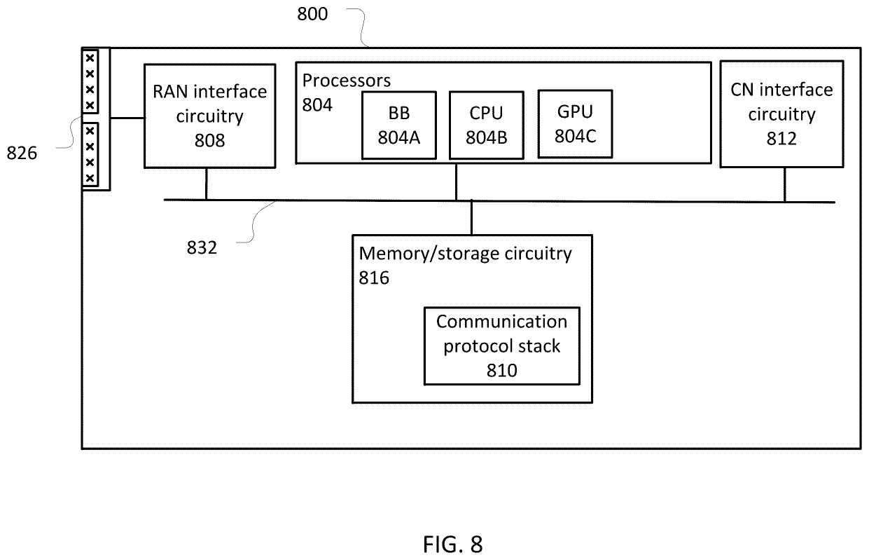

FIG. 8 illustrates a network node 800 in accordance with some embodiments. The network node 800 may be similar to and substantially interchangeable with base station 108, a device implementing one of the network hops, an integrated access and backhaul (IAB) node, a network-controlled repeater, or a server in a core network or external data network.

The network node 800 may include processors 804, RF interface circuitry 808 (if implemented as an access node), the core node (CN) interface circuitry 812, memory/storage circuitry 816, and antenna structure 826.

The components of the network node 800 may be coupled with various other components over one or more interconnects 832.

The processors 804, RF interface circuitry 808, memory/storage circuitry 816 (including communication protocol stack 810), antenna structure 826, and interconnects 832 may be similar to the like-named elements shown and described with respect to FIG. 7.

The CN interface circuitry 812 may provide connectivity to a core network, for example, a 5th Generation Core network (5GC) using a 5GC-compatible network interface protocol such as carrier Ethernet protocols or some other suitable protocol. Network connectivity may be provided to/from the network node 800 via a fiber optic or wireless backhaul. The CN interface circuitry 812 may include one or more dedicated processors or FPGAs to communicate using one or more of the aforementioned protocols. In some implementations, the CN interface circuitry 812 may include multiple controllers to provide connectivity to other networks using the same or different protocols.

In some embodiments, the network node 800 may be coupled with transmit-receive points (TRPs) using the antenna structure 826, CN interface circuitry, or other interface circuitry.

It is well understood that the use of personally identifiable information should follow privacy policies and practices generally recognized as meeting or exceeding industry or governmental requirements for maintaining users'privacy. In particular, personally identifiable information data should be managed and handled to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### Examples

In the following sections, further exemplary aspects are provided.
Example 1 includes a method to be implemented by a user equipment (UE), the method including: receiving, from a base station (BS) and on a first cell having a first subcarrier spacing (SCS), a downlink signal including information for scheduling a second cell having a second SCS and a third cell having a third SCS; determining a fourth SCS based on the second SCS and third SCS; and determining, based on the first SCS and the fourth SCS, a total number of unicast downlink control information (DCIs) to be obtained from processing the downlink signal.
Example 2 includes the method of example 1 or other examples herein, wherein said determining the total number of unicast DCIs includes: determining a UE capability; determining, based on the UE capability, a maximum number of unicast DCIs associated with the first SCS and the fourth SCS; and assigning the maximum number of unicast DCI the UE to the total number of unicast DCIs.
Example 3 includes the method of examples 1 or 2 or other examples herein, wherein the first SCS is smaller than or equal to the second SCS and the first SCS is smaller than or equal to the third SCS, and the method further includes: processing the downlink signal received in one slot to obtain unicast DCIs until a number of obtained unicast DCIs is less than or equal to the total number of unicast DCIs.
Example 4 includes the method of any of examples 1-3 or other examples herein, wherein the fourth SCS is a maximum of the second SCS and the third SCS.
Example 5 includes the method of any of examples 1-4 or other examples herein, wherein the fourth SCS is a minimum of the second SCS and the third SCS.
Example 6 includes the method of any of examples 1-5 or other examples herein, wherein said determining the total number of unicast DCIs includes: determining a UE capability; determining a first number of unicast DCIs based on the first SCS, the fourth SCS, and the UE capability; determining a second number of unicast DCIs based on the first SCS, the second SCS, and the UE capability; determining a third number of unicast DCIs based on the first SCS, the third SCS, and the UE capability; determining a fourth number of unicast DCIs based on the sum of the second number of unicast DCIs and the third number of unicast DCIs, and determining the total number of unicast DCIs based on the first number of unicast DCIs, the second number of unicast DCIs, the third number of the unicast DCIs, and the fourth number of unicast DCIs.
Example 7 includes the method of any of examples 1-6 or other examples herein, wherein the first SCS is greater than or equal to the second SCS and the first SCS is smaller than or equal to the third SCS, and the method further includes: processing the downlink signal received in a number of slots to obtain unicast DCIs until a number of obtained unicast DCIs is less than or equal to the total number of unicast DCIs.
Example 8 includes the method of any of examples 1-7 or other examples herein, wherein the fourth SCS is a maximum of the second SCS and the third SCS.
Example 9 includes the method of any of examples 1-8 or other examples herein, wherein the first SCS is smaller than or equal to the second SCS and the first SCS is smaller than or equal to the third SCS.
Example 10 includes the method of any of examples 1-9 or other examples herein, wherein said determining the total number of unicast DCIs includes: determining, based on the first SCS and the second SCS, a first total number of DCIs associated with the second cell; and determining, based on the first SCS and the third SCS, a second total number of DCIs associated with the third cell.
Example 11 includes the method of any of examples 1-10 or other examples herein, the method further including: receiving the downlink signal over a total number of slots; and determining, based on the first SCS and the fourth SCS, the total number of slots over which the downlink signal is processed to obtain the total number of unicast DCIs.
Example 12 includes the method of any of examples 1-11 or other examples herein, wherein the total number of slots is associated with slots of the first cell.
Example 13 includes the method of any of examples 1-12 or other examples herein, wherein the total number of unicast DCI is one, and the fourth SCS is a maximum of the second SCS and the third SCS.
Example 14 includes the method of any of examples 1-13 or other examples herein, wherein the total number of unicast DCI is one, and the fourth SCS is a minimum of the second SCS and the third SCS.
Example 15 includes the method of any of examples 1-14 or other examples herein, wherein said determining the total number of slots includes: determining a UE capability; determining, based on the UE capability, a maximum number of slots associated with the first SCS and the fourth SCS; and assigning the maximum number of slots to the total number of slots.
Example 16 includes the method of any of examples 1-15 or other examples herein, further including: configuring the UE to process a number of DCIs within a slot of the first cell, the number of DCIs is less than or equal to the total number of unicast DCIs.
Example 17 includes a method to be implemented by a network device, the method including: receiving, from a user equipment (UE), a UE capability information; determining a first cell to be a scheduling cell having a first subcarrier spacing (SCS) and a second cell to be a first scheduled cell having a second SCS and a third cell to be a second scheduled cell having a third SCS; determining, based on the first SCS and the second SCS and the third SCS and the UE capability, a total number of unicast downlink control information (DCIs) to be transmitted to the UE; determining, based on the first SCS and the second SCS and the third SCS and the UE capability, a total number of slots over which the total number of unicast DCIs are transmitted to the UE; and generating the unicast DCIs to be transmitted to the UE.
Example 18 includes the method of example 17 or other examples herein, wherein said determining the total number of unicast DCIs is based on the first SCS and a maximum of the second SCS and the third SCS.
Example 19 includes the method of examples 17 or 18 or other examples herein, wherein said determining the total number of unicast DCIs is based on the first SCS and a minimum of the second SCS and the third SCS.
Example 20 includes the method of any of examples 17-19 or other examples herein, wherein said determining the total number of slots is based on the first SCS and a maximum of the second SCS and the third SCS.

Example 21 includes the method of any of examples 17-20 or other examples herein, wherein said determining the total number of slots is based on the first SCS and a minimum of the second SCS and the third SCS.

Another example may include an apparatus comprising logic, modules, or circuitry to perform one or more elements of a method described in or related to any of examples 1-21, or any other method or process described herein.

Another example may include a method, technique, or process as described in or related to any of examples 1-21, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-21, or portions thereof.

Another example includes a signal as described in or related to any of examples 1-21, or portions or parts thereof.

Another example may include a datagram, information element, packet, frame, segment, PDU, or message as described in or related to any of examples 1-21, or portions or parts thereof, or otherwise described in the present disclosure.

Another example may include a signal encoded with data as described in or related to any of examples 1-21, or portions or parts thereof, or otherwise described in the present disclosure.

Another example may include a signal encoded with a datagram, IE, packet, frame, segment, PDU, or message as described in or related to any of examples 1-21, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Another example may include a computer program comprising instructions, wherein execution of the program by a processing element is to cause the processing element to carry out the method, techniques, or process as described in or related to any of examples 1-21, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a downlink signal received from a base station (BS) on a first cell having a first subcarrier spacing (SCS), the downlink signal including information for scheduling a second cell having a second SCS and a third cell having a third SCS;
determining a fourth SCS based on the second SCS and third SCS; and
determining, based on the first SCS and the fourth SCS, a total number of unicast downlink control information (DCIs) to be obtained from processing the downlink signal.

2. The method of claim 1, wherein said determining the total number of unicast DCIs comprises:
determining a user equipment (UE) capability;
determining, based on the UE capability, a maximum number of unicast DCIs associated with the first SCS and the fourth SCS; and
assigning the maximum number of unicast DCI to the total number of unicast DCIs.

3. The method of claim 1, wherein the first SCS is smaller than or equal to the second SCS, the first SCS is smaller than or equal to the third SCS, and the method further comprises:
processing the downlink signal received in one slot to obtain unicast DCIs until: all unicast DCIs in the downlink signal are obtained; or a number of obtained unicast DCIs is equal to the total number of unicast DCIs.

4. The method of claim 3, wherein the fourth SCS is a maximum of the second SCS and the third SCS.

5. The method of claim 3, wherein the fourth SCS is a minimum of the second SCS and the third SCS and said determining the total number of unicast DCIs comprises:
determining a user equipment (UE) capability;
determining a first number of unicast DCIs based on the first SCS, the fourth SCS, and the UE capability;
determining a second number of unicast DCIs based on the first SCS, the second SCS, and the UE capability;
determining a third number of unicast DCIs based on the first SCS, the third SCS, and the UE capability;
determining a fourth number of unicast DCIs based on a sum of the second number of unicast DCIs and the third number of unicast DCIs; and
determining the total number of unicast DCIs based on the first number of unicast DCIs, the second number of unicast DCIs, the third number of unicast DCIs, and the fourth number of unicast DCIs.

6. The method of claim 1, wherein the first SCS is greater than or equal to the second SCS and the first SCS is smaller than or equal to the third SCS, and the method further comprises:
processing the downlink signal received in a number of slots to obtain unicast DCIs until: all unicast DCIs in the downlink signal are obtained; or a number of obtained unicast DCIs is equal to the total number of unicast DCIs.

7. The method of claim 1, wherein the first SCS is smaller than or equal to the second SCS and the first SCS is smaller than or equal to the third SCS.

8. The method of claim 7, wherein said determining the total number of unicast DCIs comprises:
determining, based on the first SCS and the second SCS, a first total number of DCIs associated with the second cell; and
determining, based on the first SCS and the third SCS, a second total number of DCIs associated with the third cell.

9. The method of claim 7, the method further comprising:
processing the downlink signal received over a total number of slots; and
determining, based on the first SCS and the fourth SCS, the total number of slots over which the downlink signal is processed to obtain the total number of unicast DCIs.

10. The method of claim 9, wherein:
the total number of slots is associated with slots of the first cell;
the total number of unicast DCIs is one, and the fourth SCS is a maximum of the second SCS and the third SCS; or
the total number of unicast DCIs is one, and the fourth SCS is a minimum of the second SCS and the third SCS.

11. The method of claim 9, wherein said determining the total number of slots comprises:
determining a UE capability;
determining, based on the UE capability, a maximum number of slots associated with the first SCS and the fourth SCS; and
assigning the maximum number of slots to the total number of slots.

12. An apparatus comprising:
processing circuitry to:
process a downlink signal received from a base station (BS) on a first cell having a first subcarrier spacing (SCS), the downlink signal including information for scheduling a second cell having a second SCS and a third cell having a third SCS;
determine a fourth SCS based on the second SCS and third SCS; and
determine, based on the first SCS and the fourth SCS, a total number of unicast downlink control information (DCIs) to be obtained from processing the downlink signal; and
interface circuitry communicatively coupled with the processing circuitry to enable communication.

13. The apparatus of the UE of claim 12, wherein to determine the total number of unicast DCIs the processing circuitry is to:
determine a user equipment (UE) capability;
determine, based on the UE capability, a maximum number of unicast DCIs associated with the first SCS and the fourth SCS; and
assign the maximum number of unicast DCIs to the total number of unicast DCIs.

14. The apparatus of claim 12, wherein the first SCS is smaller than or equal to the second SCS and the first SCS is smaller than or equal to the third SCS, and the processing circuitry is further to:
process the downlink signal received in one slot to obtain unicast DCIs until: all unicast DCIs in the downlink signal are obtained; or a number of obtained unicast DCIs is equal to the total number of unicast DCIs.

15. The apparatus of claim 12, wherein the first SCS is greater than or equal to the second SCS and the first SCS is smaller than or equal to the third SCS, and the processing circuitry is further to:
process the downlink signal received in a number of slots to obtain unicast DCIs until a number of obtained unicast DCIs is less than or equal to the total number of unicast DCIs.

16. The apparatus of claim 12, wherein the first SCS is smaller than or equal to the second SCS and the first SCS is smaller than or equal to the third SCS and the processing circuitry is further to:
process the downlink signal received over a total number of slots; and
determine, based on the first SCS and the fourth SCS, the total number of slots over which the downlink signal is processed to obtain the total number of unicast DCIs.

17. A method comprising:
processing a user equipment (UE) capability information received from a UE;
determining a first cell to be a scheduling cell having a first subcarrier spacing (SCS) and a second cell to be a first scheduled cell having a second SCS and a third cell to be a second scheduled cell having a third SCS;
determining, based on the first SCS and the second SCS and the third SCS and the UE capability, a total number of unicast downlink control information (DCIs) to be transmitted to the UE;
determining, based on the first SCS and the second SCS and the third SCS and the UE capability, a total number of slots over which the total number of unicast DCIs are transmitted to the UE; and
generating the unicast DCIs to be transmitted to the UE.

18. The method of claim 17, wherein said determining the total number of unicast DCIs is based on the first SCS and a maximum of the second SCS and the third SCS.

19. The method of claim 17, wherein said determining the total number of unicast DCIs is based on the first SCS and a minimum of the second SCS and the third SCS.

20. The method of claim 17, wherein said determining the total number of slots is based on: the first SCS and a maximum of the second SCS and the third SCS or the first SCS and a minimum of the second SCS and the third SCS.
